(19) United States
(12) Patent Application Publication
(10) Pub. No.: US 2002/0181771 A1
(43) Pub. Date: Dec. 5, 2002

(54) Block-based image segmentation method and system

(75) Inventors: Wanqing Li, Hurstville (AU); Philip Ogunbona, Fairy Medow (AU); Jian Zhang, Enfield (AU); Xing Zhang, Menai (AU)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/845,984

(22) Filed: Apr. 30, 2001

(51) Int. Cl. G06K 9/34

(52) U.S. Cl. 382/173

(57) ABSTRACT

A method of image segmentation is disclosed. The method partitions at least part of an input image (9, 29) into a plurality of partitioned units (10). The method next determines segments (13,14,15,16) for each of the plurality of partitioned units (10) based on at least one pixel attribute of the input image (9, 29). Subsequently, the method selectively combines (18) the segments of the partitioned units (10) to provide a segmented version of the input image (9, 29). A system (1) for image segmentation having an image partition module (2), a block segmentation module (4) coupled to the image partition module (2) and a segment combination module (5) coupled to the block segmentation module (4) is also disclosed for performing the above method.

### FIELD OF THE INVENTION

This invention relates, generally, to an image segmentation method and system, and more particularly, to a method and system for merging segments of a number of image blocks or sub-images into segments of the entire image.

### BACKGROUND OF THE INVENTION

Image segmentation or partitioning is often used for image analysis, processing and pattern recognition of video information or still pictures. In general, segmentation can be defined as the decomposition of an image into segments or regions that are homogeneous in terms of a set of specified image features. The regions are semantically meaningful in the context of the environment in which the segmentation output is to be used. The selection of the feature set is usually application dependent so that the regions defined by the attributes are meaningful in that application. For images of most natural sceneries, luminance, chrominance and/or texture are often used as the features.

Furthermore, segmentation attempts to recover the scenery from an image. It is usually a non-linear optimisation process over the feature space that is used to define the homogeneity of the segments of the image. For instance, colour image segmentation aims to minimise the difference in colour within each segment and maximise the difference in colour between segments.

A typical segmentation algorithm is recursive and begins by checking the homogeneity between a pixel and its neighbours. Pixels that have homogeneous features and are spatially connected together are grouped into the same segments or regions. It is well documented and reported that the global information representing an image should be used in order to achieve meaningful segments. This practice often leads to large memory requirements to store the entire image and computational overheads to achieve a desirable segmentation.

The efficiency of an algorithm is typically given by a measure of its complexity (execution time) and memory requirement. One typical segmentation algorithm is based on a shortest spanning tree (SST) technique and its efficiency measurements are:

complexity in the order of N^{p}, denoted as O(N^{p}); and

memory requirement in the order of kN, denoted as O(kN)

where

N is the size of the image in pixels;

p is a constant of a value greater than or equal to 2; and

k is a constant of a value greater than 1.

Such an algorithm may take an unacceptable amount of time to segment an image or video frame on a device with limited auxiliary memory and processing power.

Furthermore, for a video input comprising a sequence of image frames, the requirement for an entire video frame to be buffered before the segmentation can be initiated implies that a large latency will be incurred by a segmentation process.

In this specification, including the claims, the terms “comprises”, “comprising” or similar terms are intended to mean a non-exclusive inclusion, such that a method or apparatus that comprises a list of elements does not include those elements solely, but may well include other elements not listed.

### BRIEF SUMMARY OF THE INVENTION

According to one aspect of the invention, there is provided a method of image segmentation involving the following steps. The method first partitions at least part of an input image into a plurality of partitioned units. The method next determines segments for each of the plurality of partitioned units based on at least one pixel attribute of the input image. Subsequently, the method selectively combines the segments of the partitioned units to provide a segmented version of the input image.

Preferably, the step of selectively combining should be effected by a shortest spanning tree technique.

Suitably, the step of selectively combining may include the following steps. In performing the step of selectively combining, the method represents the segments for each of the plurality of partitioned units as nodes of a tree connected via links. Each of the links has a weight based on the at least one pixel attribute. The method next finds a least weight link and combines two nodes connected by the least weight link to form a merged node. The method then connects the merged node to nodes adjacent the two nodes via new weighted links. The method repeats the steps of finding, combining and connecting until a predetermined number of nodes representing the segmented version of the input image remain in the tree.

Suitably, the step of partitioning may further include a step of generating connectivity information associated with the partitioned units.

Suitably, the nodes of the tree may be connected using the connectivity information.

Preferably, the partitioned units should include square blocks.

Preferably, the step of determining segments should be effected by a shortest spanning tree technique.

According to another aspect of the invention, there is provided a system for image segmentation having an image partition module, a block segmentation module coupled to the image partition module and a segment combination module coupled to the block segmentation module. In use the image partition module partitions at least part of an input image into a plurality of partitioned units, the block segmentation module determines segments for each of the plurality of partitioned units based on at least one pixel attribute of the input image and the segment combination module selectively combines the segments of the partitioned units to provide a segmented version of the input image.

Preferably, the system should further include a feature extraction module coupled to the block segmentation module. In use the feature extraction module determines the at least one pixel attribute of the input image.

### BRIEF DESCRIPTION OF THE DRAWINGS

In order that the invention may be readily understood and put into practical effect reference will now be made to a preferred embodiment as illustrated in the following drawings in which:

FIG. 1 shows a schematic block diagram of an image segmentation system according to the present invention;

FIG. 2 shows an example of partitioning an image into image blocks;

FIG. 3 shows a flow chart of a method for segmenting an image block of FIG. 2 using a shortest spanning tree (SST) technique on a weighted network;

FIG. 4 shows a flow chart of a method for combining segments of the image blocks into segments of the entire image of FIG. 2 using a SST technique;

FIG. 5 shows an example of an image consisting of 36 pixels arranged as 6 rows by 6 columns divided into four image blocks;

FIG. 6 shows how the method in FIG. 3 segments an upper left image block of the image in FIG. 5; and

FIG. 7 shows how the method in FIG. 4 combines the segments of the four image blocks of FIG. 5 to obtain the segments of the entire image of FIG. 5.

### DETAILED DESCRIPTION OF A PREFERRED EMBODIMENT OF THE INVENTION

In FIG. 1 there is illustrated a block based image segmentation system 1 including an input terminal T coupled to an image partition module 2. The image partition module 2 has an output coupled to a block segmentation module 4, a segment combination module 5 and a feature extraction module 3. An output of the feature extraction module 3 is coupled to both the image partition module 2 and the block segmentation module 4. The block segmentation module 4 has an output coupled to the segment combination module 5 that has an output 8. The segment combination module 5 includes a processing unit 7 and an intermediate data storage unit 6 coupled to each other by a bi-directional data bus. In use, the image partition module 2 divides or partitions an image received at the input terminal T into smaller partitioned units (PUs), so that the block segmentation module 4 can segment each block independently using limited memory and processing power.

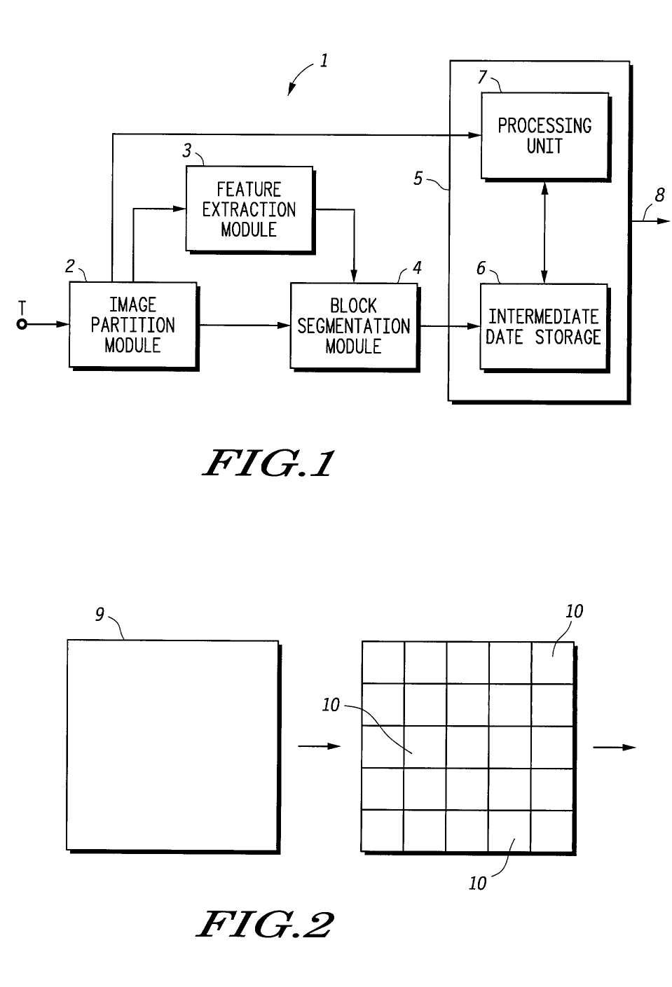

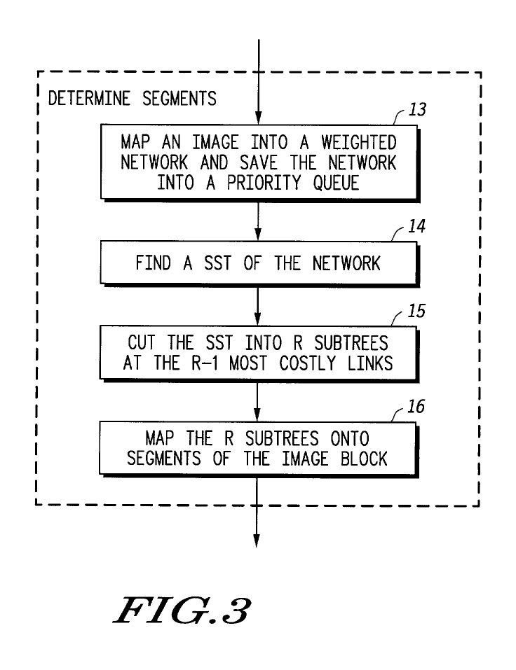

In FIG. 2, there is shown an example of partitioning an image 9 into the PUs, called image blocks 10, by the image partition module 2. Although square image blocks 10 have been illustrated, partitioning may be more complex and can result in PUs, each of which may be of any shape and size. The image partition module 2 also sends connectivity information of the image blocks 10 to the segment combination module 5.

The image blocks 10 generated by the image partition module 2 are then passed to the feature extraction module 3 where features used to define the characteristic of image segments are obtained from pixel attributes within each image block 10. The attributes of pixel i are usually represented as a vector, fᵢ=(fᵢ₁, fᵢ₂, . . . fᵢₚ), where fᵢⱼ is the j^{th} component. The attributes include luminance, chrominance and texture. Colour segmentation uses pixel luminance and chrominance and textural segmentation uses pixel texture for segmentation. Any existing feature extraction technique can be used to implement the feature extraction module 3.

Referring again to FIG. 1, the block segmentation module 4 decomposes each image block 10 into segments or regions using the feature or features extracted by the feature extraction module 3. Alternatively, the feature or features may be predetermined; in which case, the feature extraction module 3 is optional. Any known segmentation technique, such as region splitting and growing, pixel classification, edge detection and shortest spaning tree, can be used or modified to implement the block-segmentation module 4. An example of how a block is decomposed into segments will be described later.

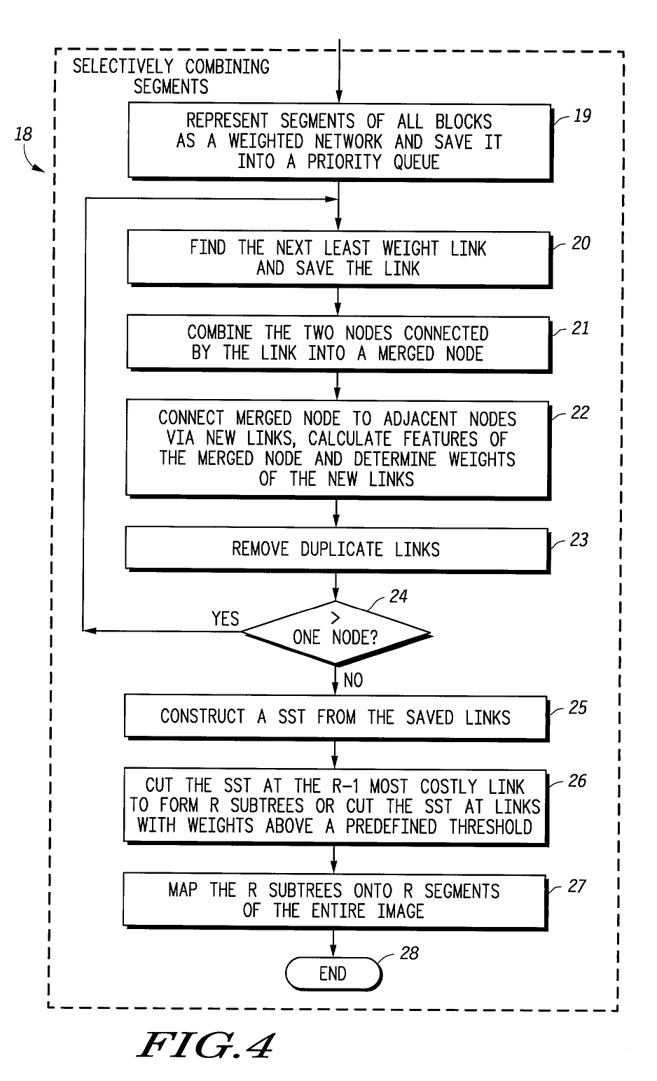

In FIG. 3 there is illustrated a method of segmenting the image 9 by using a SST technique on a weighted network. The method is effected by the block segmentation module 4. The image 9 is mapped into the weighted network in Step 13. An example of such a network is shown in FIG. 6. Each node in the network represents a pixel and an edge or a link between two nodes represents two corresponding pixels that are spatially connected. For an image represented as an array of pixels on a grid in 2D space, two pixels are defined to be spatially connected if the pixels are orthogonally adjacent to each other in the case of a 4-connectivity network and orthogonally or diagonally adjacent to each other in the case of an 8-connectivity network. The following example shows pixels X spatially connected to a pixel A in a 4-connectivity network.

$$\begin{matrix} & X & \\ X & A & X \\ & X & \end{matrix}$$

In contrast, the pixels X spatially connected to a pixel A in an 8-connectivity network would be as follows:

$$\begin{matrix}X & X & X \\ X & A & X \\ X & X & X\end{matrix}$$

The weight of the link connecting a pixel i and a pixel j is a function of their attribute vectors, fᵢ and fⱼ. Euclidean distance is often used as the weight measurement. The network is stored in a priority queue.

After the network is mapped and saved in the priority queue in Step 13, any existing algorithm, such as the Kruskal's algorithm, may be applied to find its minimum or SST in Step 14 and the SST is passed to Step 15. Information on the Kruskal's algorithm can be found in most books on algorithms, such as “Algorithmics: Theory and Practice,” Brassard and Bratley, Prentice Hall, 1988. In Step 15, the SST is cut into R sub-trees at the R-1 most costly links if it is predetermined that R segments or regions of the image block 10 are required. Alternatively, the SST can be cut at the links whose weights are above a predetermined threshold. The R sub-trees are mapped back onto R segments in image space in Step 16 and the R segments are output to the intermediate storage unit 6 in the segment combination module 5. This SST based block segmentation method will be illustrated in detail later.

Referring again to FIG. 1, the segment combination module 5 includes two units: the intermediate data storage 6 and the processing unit 7. An input of the intermediate data storage 6 is coupled to an output of the block segmentation module for storing segments of all image blocks 10 generated by the block segmentation module 4. After all image blocks 10 have been segmented by the block segmentation module 4, the processing unit 7 starts to selectively combine segments of all image blocks 10 into segments of the entire image according to certain criteria to produce a segmented version of the image. In general, combining of segments can start as soon as two blocks have been segmented. The processing unit 7 combines all block segments to form the segments of the entire image using the connectivity information and compatible optimisation criteria used in performing block segmentation. The quality of segmentation by combining block segments should preferably be comparable with segments obtained by applying the same segmentation algorithm to the entire image. The processing unit 7 utilises a global information representing the image 9 to transform the selectively combined block segments into the image segments.

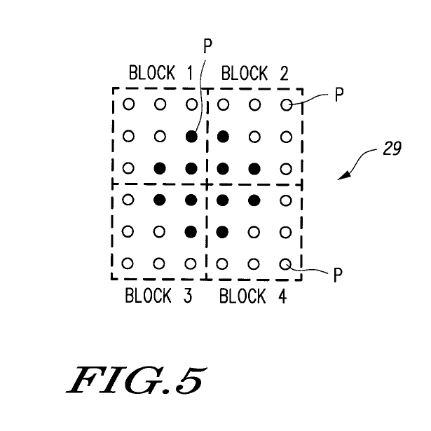

The operation of the segment combination module 5 is illustrated in FIG. 4. which shows a method 18 for combining segments. At a mapping step 19, all block segments are mapped into a weighted network according to connectivity information of segments within a block and across blocks in the processing unit 7. In the network, a node represents a block segment and a link represents the connectivity between two block segments. The weight associated with a link is a measurement of the degree of homogeneity between the two block segments connected by the link.

The connectivity information of segments within a block is passed from the block segmentation module 4 either explicitly or implicitly. The connectivity information of segments across blocks is passed from the image partition module 2 either in an explicit format for blocks of irregular shapes or in an implicit format for regular blocks, such as rectangular or square blocks.

The weight of a link between segments Rᵢ and Rⱼ with attribute vectors, fᵢ and fⱼ, is calculated as a Euclidean distance between fᵢ and fⱼ, d(fᵢ,fⱼ), multiplied by a factor depending on the sizes of the segments, Rᵢ and Rⱼ.

$${w}_{ij} = d ( {f}_{i} , {f}_{j} ) \times \frac{{S}_{i} \times {S}_{j}}{{S}_{i} + {S}_{j}} , \qquad \text{(Eq-1)}$$

where Sᵢ and Sⱼ are the sizes (in pixels) of segments Rᵢ and Rⱼ respectively.

The processing unit 7 finds an SST of the network stored in a priority queue in a recursive manner comprising Steps 20, 21, 22, 23, and 24. Step 20 involves a sorting process for selecting a link with a least weight. The selected link is saved and the two nodes connected by the link are merged into a new node V in Step 21. In this regard, let Vᵢ and Vⱼ be the two nodes connected by the selected link and fᵢ and fⱼ be their feature vectors respectively. The newly merged node shall have an attribute vector

$$f = \frac{{S}_{i} \times {f}_{i} + {S}_{j} \times {f}_{j}}{{S}_{i} + {S}_{j}} \qquad \text{(Eq-2)}$$

where Sᵢ and Sⱼ are the sizes (in pixels) of the nodes Vᵢ and Vⱼ respectively.

In Step 22, the newly merged node V is used to replace nodes Vᵢ and Vⱼ. All unprocessed links that previously connect to nodes Vᵢ and Vⱼ are now connected to the new node V. The weights of these unprocessed links are recalculated using the attribute vector f of the new node V. All duplicated links are removed from the network by Step 23. This ends the processing of one link. Step 24 checks whether there are any more unprocessed links by checking if there is more than one node remaining in the network. If there are any unprocessed links then Steps 20, 21, 22, 23 are repeated.

A SST is then constructed from the saved links in Step 25. This SST represents the entire image in a hierarchical organization with its root node being the entire image as one segment and its leaf nodes being block segments. The SST can be partitioned or cut at various levels so that the entire image is segmented into various numbers of segments. At Step 26 the SST is cut into R sub-trees at its R-1 most costly links. Information on the cost assessment of the links can be found in most books on algorithms, such as “Algorithmics: Theory and Practice,” Brassard and Bratley, Prentice Hall, 1988. At Step 27, these sub-trees are mapped back onto the image space to form R segments of the entire image.

The output from Step 27 is the final segmentation of the entire image by using the system 1 and the combining method 18 described above. The system 1 can be implemented in either a sequential or a parallel mode. The number of blocks that can be processed concurrently in the parallel mode depends on system resources available.

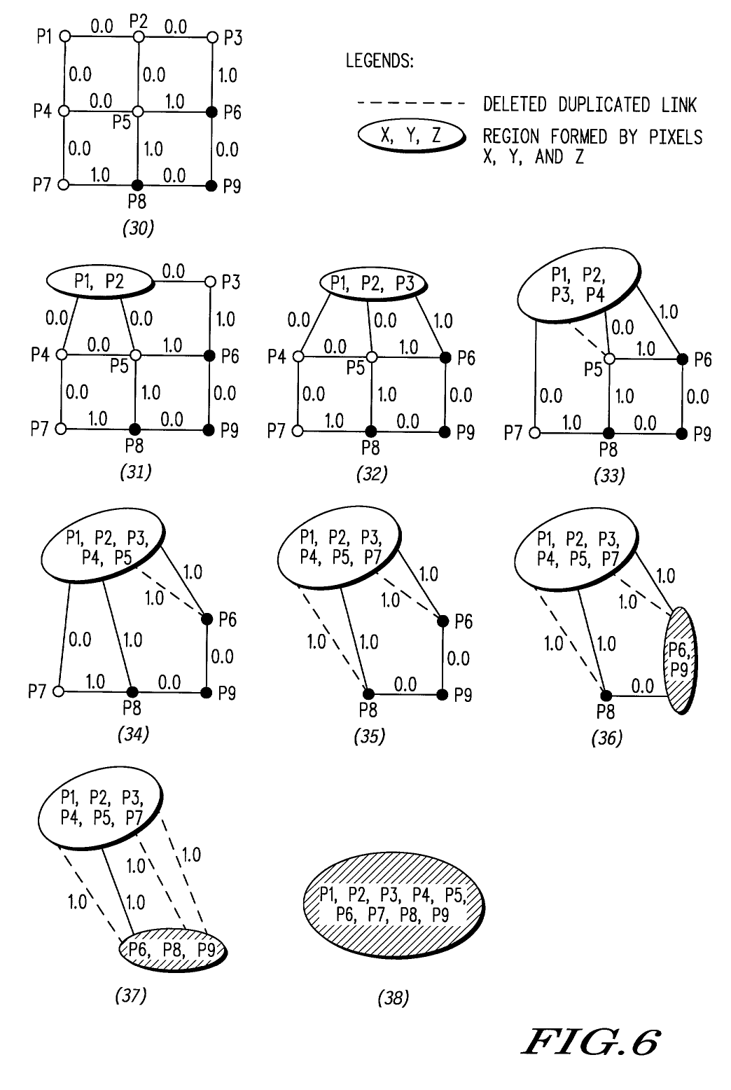

Referring to FIG. 5 there is illustrated an example image 29 comprising thirty-six pixels P that are either black or white. A white pixel has an intensity of 1.0 and a black pixel has an intensity of 0.0. The intensity is selected as the attribute to decompose the image into segments. Using the segmentation method will result in the steps below.

First, the image 29 is partitioned into four image blocks (Block 1 to Block 4) by the image partition module 2, each having 3 by 3 pixels. No connectivity information of the blocks is passed to the segment combination module 5 for such division of the image 29. The connectivity information in such a case is implicit as the image blocks are of a regular shape and size.

Then, each image block (Block 1 to Block 4) is segmented using the SST technique. FIG. 6 shows the process of segmenting Block 1 of FIG. 5. Block 1 is mapped into a 4-connectivity network (30) where pixels P are labelled from P1 to P9. The weight of each link is calculated as the Euclidean distance in intensity between two pixels connected by the link. The weight value is indicated next to the link in the network (30). Networks (31) to (38) in FIG. 6 show steps to find a shortest spanning tree of the network (30). At each step, the following operations are conducted:

1. Find a link with the least weight and save the link;

2. Merge the two nodes connected by the link into one merged node. The size of a merged node in pixel is the sum of the sizes of the two nodes and the intensity of the merged node is calculated using Eq-2. If a node comprises a single pixel, its size is one.

3. Recalculate the weights of links that are connected to the merged node using Eq-1.

4. Remove duplicated links.

These operations are repeated (as shown in networks 31-38) until all links are processed to leave only one node (38) in the network. Networks (31)-(38) form the hierarchical representation of a SST of the network (30). If two segments are required, the SST should be cut at the level that is demonstrated in network (37). Network (37) has two segments; one segment consisting of white pixels P1, P2, P3, P4, P5 and P7 and another consisting of black pixels P6, P8 and P9.

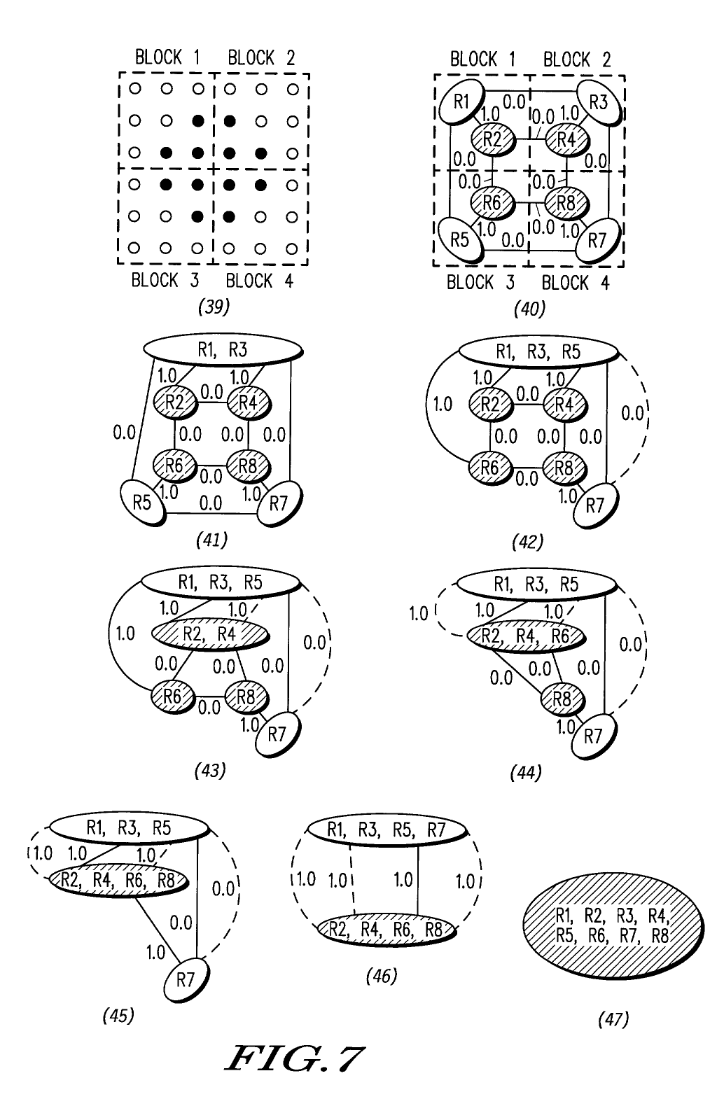

The block segmentation described above is also applicable to the rest of the three image blocks (Block 2, Block 3 and Block 4). Once all blocks (Block 1 to Block 4) have each been segmented into two segments as shown in a network 40 of FIG. 7, the block segments are combined into segments of the entire image 29 using the combining method 18 involving the same SST technique used in block segmentation.

The network 40 is mapped from the segments of the four image blocks (Block 1 to Block 4) using 4-connectivity. In network 40, nodes R1, R3, R5 and R7 represent the segments formed by the white pixels in Blocks 1, 2, 3 and 4 respectively and nodes R2, R4, R6 and R8 represent the segments formed by the black pixels in Block 1, 2, 3 and 4 respectively. Networks (41)-(47) show the steps to construct a SST of the network 40. For each step, the same four operations described above are applied. If the SST is cut at the level shown in network (46), two segments of the entire image can be obtained, one segment is formed by all black pixels and another formed by all white pixels.

Advantageously, the present invention results in efficient image segmentation. The efficiency measurements for the image segmentation can be determined as follows:

complexity of

$$O ( {n}^{p} ) \times ( \frac{N}{n} ) + A ;$$

and

memory requirement of O(kn)+B;

for a sequential mode implementation and

complexity of O(n^{p})+A; and

memory requirement of O(kN)

for a parallel mode implementation;

where

N is the size of the entire image;

p is a constant of a value greater than or equal to 2;

k is a constant of a value greater than 1;

n is the size of a block;

A accounts for computational overhead associated with the combining method; and

B accounts for the additional memory required for storing the block segments.

Information on determining such efficiency measurements can be found in most books on algorithms, such as “Algorithmics: Theory and Practice,” Brassard and Bratley, Prentice Hall, 1988.

Comparing these measurements with those of the prior art, it should be noted that:

$$O ( {n}^{p} ) \times ( \frac{N}{n} ) \leq O ( {N}^{p} )$$

O(kn)+B≦O(kN)

The larger the size of the original image, N, the more significant will be the reduction in execution time and memory requirement.

Although the invention has been described with reference to the preferred embodiment, it is to be understood that the invention is not restricted to the embodiment described herein. For example, although the invention was illustrated with reference to a black and white image, grey scale or colour images can also be segmented. As another example, block segmentation may be performed using methods other than the SST technique. The block segments produced can then be combined by a method such as the combining method described above.

We claim:

1. A method of image segmentation comprising the steps of:
partitioning at least part of an input image into a plurality of partitioned units;
determining segments for each of said plurality of partitioned units based on at least one pixel attribute of said input image; and
selectively combining said segments of said partitioned units to provide a segmented version of said input image.

2. A method according to claim 1, wherein said step of selectively combining is effected by a shortest spanning tree technique.

3. A method according to claim 2, wherein said step of selectively combining includes the steps of:
representing said segments for each of said plurality of partitioned units as nodes of a tree connected via links, each of said links having a weight based on said at least one pixel attribute;
finding a least weight link;
combining two nodes connected by said least weight link to form a merged node;
connecting said merged node to nodes adjacent said two nodes via new weighted links;
repeating said steps of finding, combining and connecting until a predetermined number of nodes representing said segmented version of said input image remain in said tree.

4. A method according to claim 3, wherein said step of partitioning further includes:
generating connectivity information associated with said partitioned units.

5. A method according to claim 4, wherein said nodes of said tree are connected using said connectivity information.

6. A method according to claim 1, wherein said partitioned units includes square blocks.

7. A method according to claim 1, wherein said step of determining segments is effected by a shortest spanning tree technique.

8. A system for image segmentation comprising:
an image partition module;
a block segmentation module coupled to said image partition module; and
a segment combination module coupled to said block segmentation module;
wherein in use said image partition module partitions at least part of an input image into a plurality of partitioned units, said block segmentation module determines segments for each of said plurality of partitioned units based on at least one pixel attribute of said input image and said segment combination module selectively combines said segments of said partitioned units to provide a segmented version of said input image.

9. A system according to claim 8, further comprising:
a feature extraction module coupled to said block segmentation module;
wherein in use said feature extraction module determines said at least one pixel attribute of said input image.

10. A system according to claim 8, wherein said partitioned units includes square blocks.

11. A system according to claim 8, wherein said block segmentation module determines segments by a shortest spanning tree technique.

12. A system according to claim 8, wherein said segment combination module selectively combines said segments by a shortest spanning tree technique.

13. A system according to claim 8, wherein said segment combination module selectively combines said segments by performing the steps of:
representing said segments for each of said plurality of partitioned units as nodes of a tree connected via links, each of said links having a weight based on said at least one pixel attribute;
finding a least weight link;
combining two nodes connected by said least weight link to form a merged node;
connecting said merged node to nodes adjacent said two nodes via new weighted links;
repeating said steps of finding, combining and connecting until a predetermined number of nodes representing said segmented version of said input image remain in said tree.

14. A system according to claim 8, wherein said image partition units further generates connectivity information associated with said partitioned units.

15. A system according to claim 14, wherein said nodes of said tree are connected using said connectivity information.
